(19) United States
(12) Patent Application Publication
(10) Pub. No.: US 2010/0171016 A1
(43) Pub. Date: Jul. 8, 2010

(54) CROSS MEMBER MOUNTING ADAPTER

(76) Inventor: Robert M.M. Haddock, Colorado Springs, CO (US)

Correspondence Address: MARSH, FISCHMANN & BREYFOGLE LLP, 8055 East Tufts Avenue, Suite 450, Denver, CO, 80237, US

(21) Appl. No.: 12/629,179

(22) Filed: Dec. 2, 2009

Related U.S. Application Data
(60) Provisional application No. 61/120,280, filed on Dec. 5, 2008.

(51) Int. Cl. F16B 2/00

(52) U.S. Cl. 248/237

(57) ABSTRACT

Systems are presented for the installation of a cross member (32) on a roofing surface (12). In this regard, the systems generally provide for a low-profile cross member assembly (30) for securement to a standing seam (20) on a roofing surface (12). The cross member assembly (30) includes a mounting device (34) that is attachable to a standing seam (20) of a roofing surface (12) and a detachably mounted adapter (36) having a flat first adapter section (60) that may parallel the roofing surface (12). A second adapter section (62) forms a cross member-receiving aperture (74) with a closed perimeter to accommodate the cross member (32).

### CROSS-REFERENCE TO RELATED APPLICATIONS

This patent application claims priority under 35 U.S.C. §119(e) to pending U.S. Provisional Patent Application Ser. No. 61/120,280, that is entitled “CROSS MEMBER MOUNTING ADAPTER,” that was filed on Dec. 5, 2008, and the entire disclosure of which is hereby incorporated by reference in its entirety herein.

### FIELD

The present invention generally relates to how a cross member may be installed on a building surface.

### BACKGROUND

Metal panels are being increasingly used to define building surfaces such as roofing surfaces and sidewalls. One type of metal panel is a standing seam panel, where the edges of adjacent standing seam panels of the building surface are interconnected in a manner that defines a standing seam. It is often desirable to install various types of attachments or structures on building surfaces defined by metal panels. Examples include snow guards or snow retention devices, signs, lighting systems, ornamental items, and heating, air conditioning, and ventilation equipment. There are several drawbacks to installing attachments on metal panel building surfaces in a manner that punctures the building surface at one or more locations. First, these standing seam metal panel building surfaces are relatively expensive, so it is desirable to avoid puncturing or compromising the metal panels. Second, puncturing a metal panel building surface can lead to leakage and/or corrosion issues.

### SUMMARY

The present invention is generally directed to a cross member assembly that may be installed on a building surface, such as a roofing surface. Such a building surface may be defined by a plurality of metal panels, Adjacent metal panels may be interconnected to define a standing seam that proceeds along a slope or pitch of the building surface (e.g., each standing seam may run generally from a peak of the roof to an edge of the roof; the length dimension of each standing seam may proceed in a direction of changing elevation). In any case, the cross member assembly utilizes a mounting device (e.g., a clamp) that may be installed on a building surface, along with a separate adapter that may be detachably secured to the mounting device and that accommodates a cross member.

A first aspect of the present invention is embodied by a cross member assembly that includes a mounting device and an adapter. The mounting device includes an upper surface that projects or faces away from a roofing surface (e.g., “upwardly”) when the mounting device is installed on the roofing surface, and this upper surface includes a flat section. The mounting device also includes first and second mounting device ends that are spaced from each other proceeding along a slope of the roofing surface when the mounting device is installed on such a roofing surface.

The adapter is detachably mounted to the mounting device in the case of the first aspect—the adapter may be repeatedly installed on and removed from the mounting device as desired. The adapter includes first and second adapter sections. The first adapter section is in the form of a plate that is disposed on the flat section of the upper surface of the mounting device. The second adapter section is interconnected with the first adapter section, is disposed beyond the first mounting device end, and includes a cross member-receiving aperture or pocket that is also disposed beyond the first mounting device end. This cross member-receiving aperture is defined by a closed perimeter.

Various feature refinements and additional features are applicable to the first aspect of the present invention. These feature refinements and additional features may be used individually or in any combination. The following discussion is applicable to the first aspect, up to the start of the discussion of a second aspect of the present invention.

The mounting device may be of any appropriate size, shape, configuration, and/or type, may be formed from any appropriate material or combination of materials, may be secured to a roofing surface in any appropriate manner, and any combination thereof. In one embodiment, the mounting device includes a mounting body having a slot for receiving at least an end section of a standing seam defined on a roofing surface. This standing seam may be of any appropriate configuration and orientation. However, when the mounting device is installed on a standing seam (whether on a vertically extending end section of a standing seam or on a horizontally extending end section of a standing seam), the upper surface of the mounting device faces or projects away from the roofing surface (upwardly). Again, this upper surface of the mounting device includes at least one flat section. The entirety of the upper surface could of course be flat or planar.

One or more fasteners may be used to secure the mounting device to a roofing surface. In the case of a roofing surface that is defined by standing seam panels, one or more seam fasteners may extend through a body of the mounting device and into the above-noted slot to directly engage an exterior of a standing seam that is disposed in this slot. Any such seam fastener used to mount the mounting device to a standing seam may be configured so as to not penetrate the standing seam, but instead only to engage an exterior of the standing seam (e.g., a seam fastener having a rounded, convex, or blunt-nosed end).

The adapter may include at least one registrant that aligns the adapter relative to the mounting device (e.g., one or more structures that provides for or otherwise establishes a positional registration of the adapter to the mounting device). The adapter may include a lip that extends from the first adapter section in a different orientation than the first adapter section (e.g., a lip may be disposed orthogonally or perpendicularly to the first adapter section). The first adapter section may be characterized as being located between this lip and the second adapter section. In any case, this lip may engage the second mounting device end, which is opposite of the first mounting device end beyond which the second adapter section is disposed. This lip may be used to align the adapter relative to the mounting device, such that the adapter may be secured to the mounting device (e.g., to align a mounting hole through the first adapter section with a hole in the mounting device).

The adapter may be secured to the mounting device in any appropriate manner. For instance, one or more threaded fasteners may extend through the first adapter section of the adapter and into the mounting device (e.g., such that there is a threaded engagement between each such threaded fastener and a body of the mounting device). The above-noted lip may be used to keep the adapter from rotating relative to the mounting device as any such threaded fastener is rotated into threaded engagement with the mounting device. Each such threaded fastener could extend through a corresponding non-threaded hole in the first adapter section (whether of a single layer or multi-layer construction). A threaded hole may be included on the upper surface of the mounting device for receiving a corresponding threaded fastener. One or more self-tapping fasteners, self-drilling fasteners, or the like could also be used to secure the adapter to the mounting device, thereby alleviating the need for incorporating pre-existing threaded holes in the mounting device to accommodate securing the adapter to the mounting device.

In one embodiment, the first adapter section is in the form of a single-layer structure. No interface would be encountered proceeding through the entire thickness of the first adapter section in this particular instance. In another embodiment, the first adapter section includes a top flange and a separate bottom flange (i.e., to provide a multi-layer structure) that collectively define a flat plate when mated (e.g., the first adapter section may be characterized as a multi-layered structure in this particular instance). The second adapter section may connect with and act as a living hinge between the top and bottom flanges of the first adapter section to allow the adapter to move between an open or loading position/configuration and a closed or retention position/configuration. Specifically, the top and bottom flanges of the first adapter section may be moved apart to provide access to the cross member-receiving aperture of the second adapter section in the open position, and they may be moved together (e.g., disposed in interfacing relation) such that the second adapter section then provides the closed perimeter for the cross member-receiving aperture. In each of the noted embodiments for the first adapter section, the adapter could be an integrally-formed structure (e.g., of one-piece construction, with no joint of any kind between the first and second adapter sections).

The entirety of the first adapter section is in the form of a plate in the case of the first aspect. As such, the first adapter section includes two parallel, planar surfaces (its upper and lower surfaces) that are to separated by a distance that defines a thickness of the first adapter section. In one embodiment, the second adapter section is disposed “downhill” of the first adapter section when the cross member assembly is installed on a roofing surface, such that the first adapter section is placed in tension by snow and/or ice progressing down the roofing surface and engaging the cross member. Having the first adapter section in tension versus compression reduces the potential that the first adapter section will structurally fail in some respect (e.g., buckle).

The first adapter section may parallel a slope of a roofing surface when the cross member assembly is installed on such a roofing surface. The first adapter section could also be characterized as a strap. In any case, the second adapter section may adjoin the first adapter section. That is, in this instance there would not be an intermediate structure between the first and second adapter sections. The first adapter section could thereby extend beyond the first mounting device end to dispose the second adapter section beyond the first mounting device end.

The second adapter section may be characterized as being in the form of loop through which a cross member may extend (and which may define the noted closed perimeter for the cross member-receiving aperture). In one embodiment, the length dimension of such a cross member is orthogonal to a direction that the first and second mounting device ends of the mounting device are spaced from each other. The second adapter section may also be characterized as a bulbous structure that is disposed on an end of the first adapter section.

The second adapter section is disposed beyond the first mounting device end of the mounting device in the case of the first aspect. Stated another way, the second adapter section may be characterized as not being disposed in overlying relation to the mounting device when the cross member assembly is installed on a roofing surface. The second adapter section may be spaced from the first mounting device end of the mounting device (e.g., the first adapter section may extend beyond the first mounting device end, as noted). Any appropriate spacing between the second adapter section of the adapter and the first mounting device end of the mounting device may be utilized, for instance this spacing may be within a range of 1″-2″ in one embodiment (inclusive). There could be at least one benefit to having an even larger spacing between the second adapter mounting section and the first mounting device end. However, the second adapter section could actually contact the first mounting device end (although it still would be disposed beyond the first mounting device end).

The mounting device may be installed such that the first mounting device end is in a direction of decreasing elevation compared to the second mounting device end, such that the second adapter section is disposed in a direction of decreasing elevation compared to the first mounting device end, or both, all when the mounting device is installed on a roofing surface. Stated another way, the first mounting device end may be located “downhill” of the second mounting device end, the second adapter section may be located “downhill” of the first mounting device end, or both, all when the mounting device is installed on a roofing surface.

The second adapter section may form a cross member-receiving aperture of any appropriate size, shape, and/or configuration to accommodate receipt of a cross member. For example, the second adapter section may form an aperture having a round, oval, square, rectangular, triangular, trapezoidal, or any other standard or custom shape. In addition and regardless of whether the second adapter section resides in a direction of increasing or decreasing elevation from the first adapter section and the mounting device, the second adapter section may engage (e.g., rest upon) a standing seam to which the mounting device is attached.

A second aspect of the present invention is embodied by a roofing system having a roofing surface, a mounting device, a cross member, and an adapter. The roofing surface includes a plurality of flat base sections. The mounting device is installed on the roofing surface, and includes first and second mounting device ends that are spaced from each other proceeding along the direction in which the roofing surface slopes (e.g., one of the mounting device ends is disposed “uphill” or in a direction of increasing elevation compared to the other mounting device end). The adapter is detachably mounted to the mounting device, and includes first and second adapter sections. The first adapter section is in the form of a plate and is disposed in parallel relation to at least the adjacent-most flat base section(s) of the roofing surface. The second adapter section is interconnected with the first adapter section, is disposed beyond the first mounting device end, and includes a cross member-receiving aperture or pocket that is also disposed beyond the first mounting device end. This cross member-receiving aperture is defined by a closed perimeter.

Various feature refinements and additional features are applicable to the second aspect of the present invention. These feature refinements and additional features may be used individually or in any combination. The following discussion is applicable to the second aspect, up to the start of the discussion of a third aspect of the present invention.

Any appropriate way of having the adapter interface with the mounting device may be used. For instance, the first adapter section could be disposed in interfacing relation with a flat section of the mounting device, although such may not be required in all instances. The various features discussed above in relation to the first aspect may be used by this second aspect, individually or in any combination.

A third aspect of the present invention is embodied by a cross member assembly that includes a mounting device and an adapter. The mounting device includes an uppermost surface that projects or faces away from a roofing surface (e.g., upwardly) when the mounting device is installed on the roofing surface. The mounting device also includes first and second mounting device ends that are spaced from each other proceeding along a slope of the roofing surface when the mounting device is installed on such a roofing surface. The adapter is detachably mounted to the mounting device, extends beyond the first mounting device end, and includes a cross member-receiving aperture or pocket that is also disposed beyond the first mounting device end. This cross member-receiving aperture is defined by a closed perimeter, and at least part of this cross member-receiving aperture is disposed closer to the roofing surface than the uppermost surface of the mounting device when the cross member assembly is installed on the roofing surface. The various features discussed above in relation to the first aspect may be used by this third aspect, individually or in any combination.

A fourth aspect of the present invention is embodied by a roofing system having a roofing surface, a mounting device, a cross member, and an adapter. The roofing surface includes a plurality of standing seams. The mounting device is installed on one of these standing seams. The adapter is detachably mounted to the mounting device (e.g., via a first adapter section of the type discussed above in relation to the first aspect), but the adapter also extends beyond the mounting device. Part of the adapter that is disposed beyond the mounting device (e.g., the second adapter section discussed above in relation to the first aspect) engages or “rests upon” the standing seam on which the mounting device is installed, and furthermore includes a receiver in which the cross member is disposed. In one embodiment, the receiver is in the form of a cross member-receiving aperture defined by a closed perimeter. Other receiver configurations may be appropriate for purposes of this fourth aspect. For instance, the receiver could be U-shaped, C-shaped, or the like. However, any such receiver configuration should provide stability for the cross member when exposed to snow and/or ice sliding down the roofing surface—the cross member should not be able to become dislodged from the receiver due to sliding snow and/or ice engaging the cross member. The various features discussed above in relation to the first aspect may be used by this fourth aspect, individually or in any combination.

A number of feature refinements and additional features are separately applicable to each of above-noted first through the fourth aspects of the present invention. These feature refinements and additional features may be used individually or in any combination in relation to each of the above-noted first through the fourth aspects. Any feature of any other various aspects of the present invention that is intended to be limited to a “singular” context or the like will be clearly set forth herein by terms such as “only,” “single,” “limited to,” or the like. Merely introducing a feature in accordance with commonly accepted antecedent basis practice does not limit the corresponding feature to the singular (e.g., indicating that the cross member assembly includes a “mounting device” alone does not mean that the cross member assembly utilizes only a single mounting device). Moreover, any failure to use phrases such as “at least one” also does not limit the corresponding feature to the singular (e.g., indicating that an cross member assembly includes “a mounting device” alone does not mean that the cross member assembly includes only a single mounting device). Finally, use of the phrase “at least generally” or the like in relation to a particular feature encompasses the corresponding characteristic and insubstantial variations thereof (e.g., indicating that a surface is at least generally flat encompasses the noted surface being flat).

Multiple mounting devices may be utilized in relation to each of the above-noted aspects. Multiple mounting devices may be disposed in any appropriate arrangement on a roofing surface. Each of the multiple mounting devices may be installed on a roofing surface at a common elevation, or at a common location proceeding along the slope of the roofing surface. Any appropriate cross member may be utilized, and the cross member may be of any appropriate size, shape, configuration, and/or type. The cross member may be configured to as to interface with one or more adapters (e.g., a second adapter section thereof), but so as to not interface with or contact any mounting device. Contact with the cross member may be limited to the second adapter section of one or more adapters.

In one embodiment, the cross member provides a snow-retention function. Consider the case where the cross member extends between the cross member-receiving aperture of multiple adapters, where each adapter is mounted to a separate mounting device, and where each mounting device is installed on a sloped roofing surface. When snow and/or ice moving down the sloped roofing surface engages the cross member, each adapter may be mounted to its corresponding mounting device so as to place its first adapter section primarily in tension (e.g., the largest load exerted on the first adapter section may be a tensile force).

The second adapter section of each adapter may include a cross member-receiving aperture for receiving a cross member as discussed above. Other configurations for the cross member-receiving aperture required by the first, second, and third aspects (defined above as having a closed perimeter) may be appropriate in at least certain cases, and which do not require a closed perimeter. However, any such modification of the cross member-receiving aperture should still provide stability for the cross member when exposed to snow and/or ice sliding down the roofing surface—the cross member should not be able to become dislodged from such a cross member-receiving aperture due to sliding snow and/or ice engaging the cross member. In one embodiment, part of the second adapter section is positioned “downhill” of the entire cross member and this part engages the cross member to directly oppose forces exerted on the cross member by snow and/or ice attempting to proceed down a roofing surface (downhill being in the direction of decreasing elevation when the cross member assembly is installed on a roofing surface). In one embodiment, part of the second adapter section is disposed “downhill” of the most downhill portion of the cross member to directly oppose forces exerted on the cross member by snow and/or ice attempting to proceed down a roofing surface (downhill being in the direction of decreasing elevation when the cross member assembly is installed on a roofing surface). In one embodiment, a first part of the second adapter section that defines the cross-member receiving aperture opposes movement of the cross member away from the roofing surface (e.g., is positioned “above” the cross member), a second part of the second adapter section that defines the cross-member receiving aperture opposes movement of the cross member towards the roofing surface (e.g., is positioned “below” the cross member), and a third part of the second adapter section that defines the cross-member receiving aperture is positioned “downhill” of the cross member so as to oppose movement of the cross member down the pitch of the roofing surface.

### BRIEF DESCRIPTION OF THE FIGURES

FIG. 1 is a perspective view of one embodiment of a cross member assembly installed on a roofing surface.

FIG. 2A is an enlarged, perspective view of part of the cross member assembly of FIG. 1.

FIG. 2B is another enlarged, perspective view of part of the cross member assembly of FIG. 1.

FIG. 3 is an exploded, perspective view of one of the mounting devices from the cross member assembly of FIG. 1, along a representative configuration for a standing seam from the roofing surface on which the mounting device may be installed.

FIG. 4 is a perspective view of the adapter used by the cross member assembly of FIG. 1.

FIG. 5 is a side view of the cross member assembly of FIG. 1.

FIG. 6 is a perspective view of another embodiment of an adapter that may be used by the cross member assembly of FIG. 1.

### DETAILED DESCRIPTION

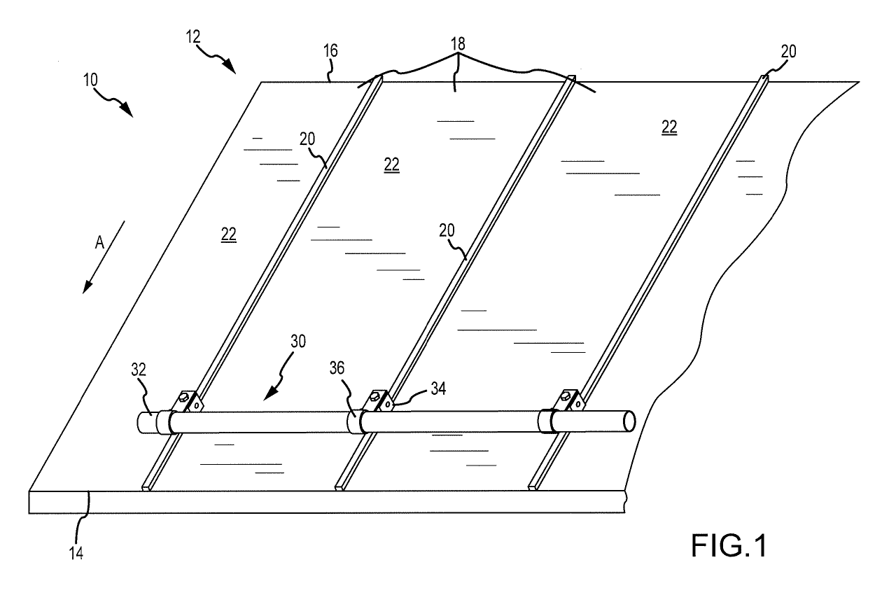

FIG. 1 presents one embodiment of what may be referred to as a roofing system 10. The roofing system 10 includes a cross member assembly 30 that is installed on a roofing surface 12 (e.g., to provide a snow retention function). Generally, the roofing surface 12 may be defined in any appropriate manner and may be of any appropriate configuration. For instance, the roofing surface 12 may include one or more roofing sections, each of which may be of any appropriate pitch/slope and/or shape. The cross member assembly 30 may be installed at any appropriate location on the roofing surface 12 and in any appropriate manner, and furthermore the cross member assembly 30 may be of any appropriate length. Multiple cross member assemblies 30 may be used and disposed in any appropriate arrangement.

The roofing surface 12 illustrated in FIG. 1 is but one representative configuration that may be utilized by the roofing system 10. The roofing surface 12 may be of any pitch, but at least generally slopes downwardly in a direction denoted by arrow A in FIG. 1 from a peak 16 of the roofing surface 12 to an edge 14 of the roofing surface 12. Multiple panels 18 (e.g., metal panels) collectively define the roofing to surface 12. The interconnection of each adjacent pair of panels 18 in the illustrated embodiment defines a standing seam 20 (only schematically illustrated in FIG. 1).

The standing seams 20 may at least generally proceed in the direction of or along the slope or pitch of the roofing surface 12 (e.g., the pitch of the length dimension of the standing seams 20 may match the pitch of the corresponding portion of the roofing surface 12). Each panel 18 includes at least one base section 22 that is at least generally flat or planar and that is disposed between each adjacent pair of standing seams 20 on the roofing surface 12. Each panel 18 could include one or more crests, minor ribs, intermediate ribs, parcel ribs, striations, fluting, or flutes between its corresponding pair of standing seams 20 so as to provide multiple base sections 22 on each panel 18 (not shown).

The panels 18 may be of any appropriate configuration so to allow them to be interconnected or nested in a manner that defines a standing seam 20, and the standing seams 20 may be disposed in any appropriate orientation relative to the base sections 22 of the panels 18 that define the standing seam 20. Generally, the standing seams 20 may be characterized as at least initially extending orthogonally (e.g., perpendicularly) relative to the base sections 22 of the corresponding panels 18. The illustrated standing seams 20 may be characterized as having a vertical end section, or as being of a vertical standing seam configuration. However, the end sections of the various standing seams 20 could also have portions that are horizontally disposed (e.g., at least generally parallel with the base sections 22 of the corresponding panels 18), or as being of a horizontal standing seam configuration.

The cross member assembly 30 is installed on the roofing surface 12. Generally, the cross member assembly 30 may be used to interconnect a cross member 32 with the roofing surface 12. While the cross member 32 may provide the function of a snow retention device, or a structure that at least attempts to impede or retard the movement of snow and/or ice down the inclined roofing surface 12, the cross member 32 may provide any appropriate function or combination of functions.

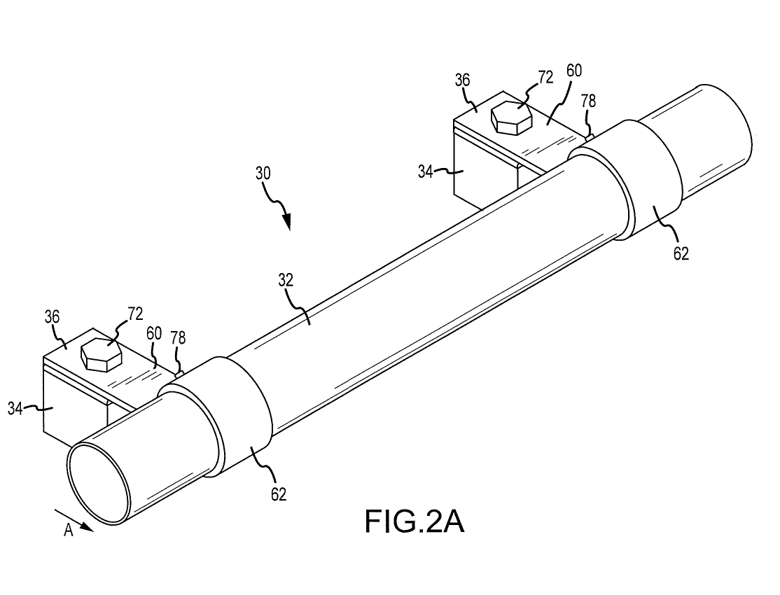

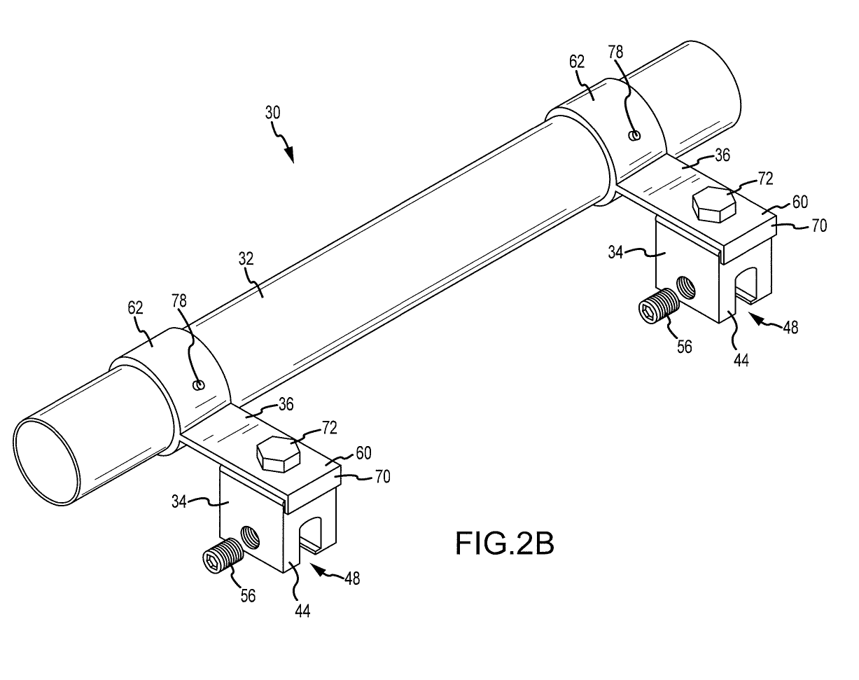

FIGS. 2A and 2B present different perspective views of part of the cross member assembly 30 shown in FIG. 1. The arrow A in FIG. 2A illustrates what may be the “downhill” direction when the cross member assembly 30 is installed on the roofing surface 12. The cross member assembly 30 generally includes at least one mounting device 34, an adapter 36 for each mounting device 34, and the above-noted cross member 32 that extends through at least one adapter 36. That is, each adapter 36 is configured to receive at least a portion of the cross member 32, as will be discussed below.

Although a single mounting device 34 and adapter 36 could be used to interconnect a cross member 32 with the roofing surface 12, multiple mounting devices 34 (again, each having a corresponding adapter 36) would typically be used in conjunction with a given cross member 32. However, any appropriate number of mounting devices 34 may be utilized by a particular cross member assembly 30. A mounting device 34 may be installed on each standing seam 20 over which its cross member 32 is disposed, although such may not be required in all instances (e.g., the cross member 32 could extend over a standing seam 20 without being interconnected therewith via a mounting device 34 and corresponding adapter 36).

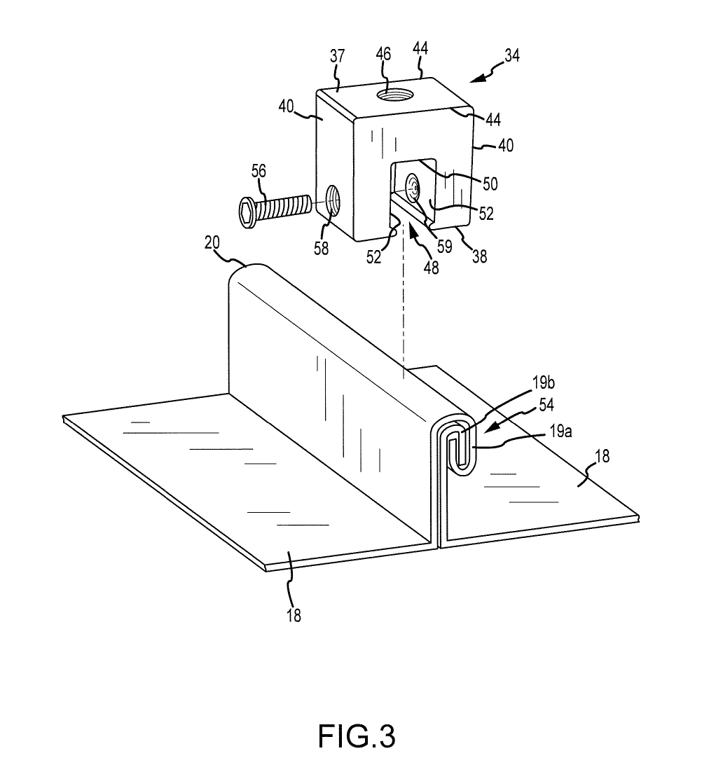

Each mounting device 34 of the cross member assembly 30 is installed on a standing seam 20 in the illustrated embodiment. FIG. 3 illustrates a perspective view of a representative configuration for a standing seam 20 that may be used by the roofing surface 12 of FIG. 1. There it can be seen that a pair of panels 18 are interconnected so as to collectively define a standing seam 20. Generally, a longitudinal edge section 19a of one panel 18 (e.g., the right edge section of the left panel 18 in the view shown in FIG. 3) is “nested” with the opposing longitudinal edge section 19b of an adjacent panel 18 (e.g., the left edge section of the right panel 18 in the view shown in FIG. 3) to collectively define the standing seam 20. This is commonly referred to as a “double folded seam” configuration. Other configurations for the “nested” longitudinal edges of the panels 18 may be utilized to provide a different configuration that still defines a standing seam 20.

Details of the mounting device 36 are shown in FIGS. 2A-2B, as well as in FIG. 3, The mounting device 34 includes an upper surface 37 and an oppositely disposed bottom surface 38, a pair of oppositely disposed side surfaces 40, and a pair of oppositely disposed ends or end surfaces 44. The upper surface 37 of the mounting device 34 is that surface which faces or projects away from the roofing surface 12 (e.g., upwardly) when the mounting device 34 is installed on the roofing surface 12 in the illustrated embodiment. The entirety of the upper surface 34 may be flat or planar, or it may include at least one flat or planar section for providing a desirable interface with a corresponding adapter 36 (e.g., the intersection between the upper surface 34 and each side surface 40 could be rounded). The upper surface 37 also includes at least one threaded mounting hole 46 configured to receive a threaded fastener 72 to secure or mount the adapter 36 to the mounting device 34. Such a threaded mounting hole 46 may be eliminated if the threaded fastener 72 is of a self-tapping or self-drilling type. Multiple threaded fasteners 72 could be used to secure the adapter 36 to the mounting device 34 as well. Generally, at least one threaded fastener 72 may be threadably engaged with the mounting device 34 to detachably mount the adapter 36 to the mounting device 34 (“detachable” meaning that an adapter 36 may be repeatedly installed on and removed from a mounting device 34).

The bottom surface 38 of the mounting device 34 includes a slot 48 that extends between the two ends 44 of the mounting device 34. The slot 48 on the bottom surface 38 of the mounting device 34 includes an upper wall 50 and a pair of sidewalls 52 that are spaced apart to receive at least an end section 54 of a standing seam 20. One or more seam fasteners 56 may be directed through a seam-mounting hole 58 in at least one of the side surfaces 40 of the mounting device 34 and into the slot 48 to engage the standing seam 20 and secure it against the opposing slot sidewall 52 or an opposing seam fastener 56 (e.g., at least one seam fastener 56 could be directed into the slot 48 from each of the two side surfaces 40 of the mounting device 34). The end of each seam fastener 56 used to secure the mounting device 34 to a standing seam 20 may be contoured so as to not penetrate the corresponding standing seam 20 (e.g., a fastener 56 having a rounded, convex, or blunt-nosed end). That is, each seam fastener 56 may only engage an exterior surface of the corresponding standing seam 20. In any case, a cavity 59 of any appropriate type, size, and/or configuration may be formed on the opposing slot sidewall 52 to allow an aligned seam fastener 56 to deflect a corresponding portion of the standing seam 20 into this cavity 59 to enhance the “locking” of the mounting device 34 onto a standing seam 20.

In the illustrated embodiment, the end section 54 of each standing seam 20 may be characterized as being vertically disposed. Again and as noted above, the end section 54 could also be at least generally horizontally disposed. In this case, each mounting device 34 would be installed on such a horizontal standing seam such that one of its side surfaces 40 faced or projected away from the roofing surface (e.g., upwardly) in the installed position on the roofing surface (e.g., in accordance with the “dual orientation” mounting device configurations addressed by U.S. Pat. No. 5,483,772, the entire disclosure of which is incorporated by reference in its entirety herein). Stated another way, the slot 48 of the mounting device 34 would be at least generally horizontally disposed in this case (in the horizontal standing seam configuration), versus vertically disposed as in FIG. 3. In such a horizontal standing seam configuration, at least part of the upwardly facing or projecting side surface 40 of the mounting device 34 should include at least one flat or planar section (or entirely flat or planar) for interfacing with the corresponding adapter 36.

Other mounting device configurations may be appropriate for installation on a standing seam 20 for use in place of the mounting device 34 shown in FIGS. 1-3. For example, various mounting device configurations are disclosed in U.S. Pat. Nos. 5,228.248; 5,483,772; 5,941,931; 5,694,721; 5,715,640; 5,983,588; 6,164,033; 6,718,718; 7,100,338; and 7,013,612, and these devices may be utilized by the mounting assembly 30. The cross member assembly 30 is also not limited for use with a standing seam roofing surface. Therefore, other mounting device configurations may be utilized by the cross member assembly 30, and adapted (if necessary) for the intended roofing surface.

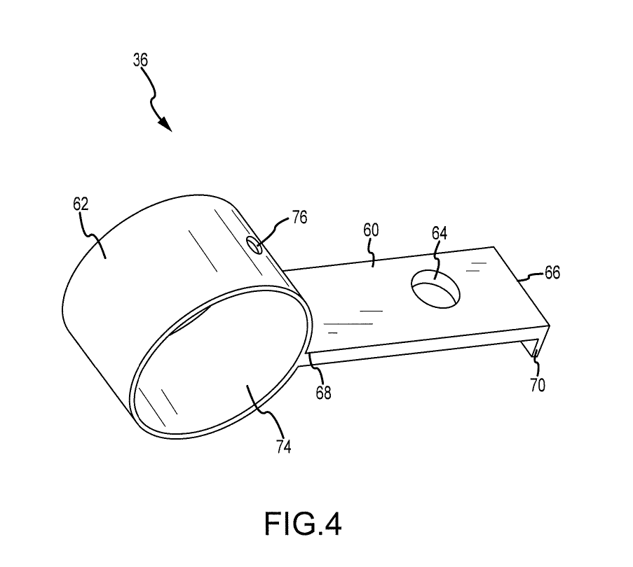

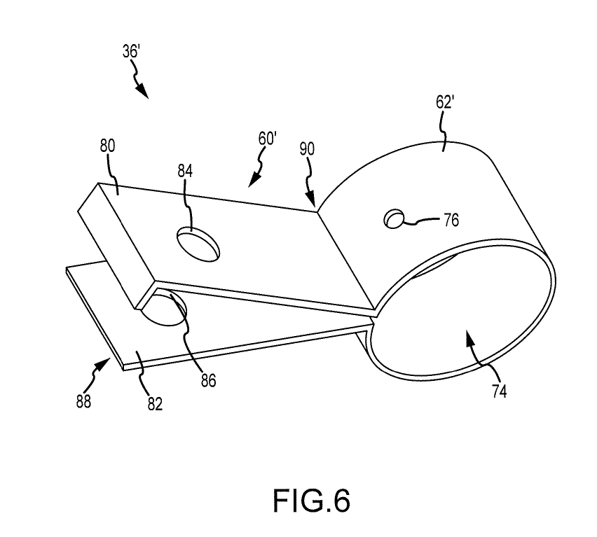

Details regarding the adapter 36 used by the cross member assembly 30 of FIG. 1 are presented in FIGS. 2A-2B, along with FIG. 4. The adapter 36 includes a first adapter section 60 and a second adapter section 62. The first adapter section 60 is in the form of a flat plate (e.g., defined by a pair of planar surfaces that are parallel and spaced by a distance that defines a thickness of the first adapter section 60) that parallels the flat base sections 22 of at least the corresponding panels 18 (those panels 18 that define the standing seam 20 to which the adapter 36 is interconnected via a mounting device 34) when the adapter 36 is attached to the mounting device 34. Stated another way, the first adapter section 60 may be disposed parallel with the pitch of the roofing surface 12. The first adapter section 60 may be characterized as being of a single layer or in the form of a single-layered construction—no interface is encountered proceeding through the thickness of the first adapter section 60 (in contrast to the embodiment of FIG. 6, discussed below).

The first adapter section 60 may be characterized as having a mounting device end 66 and an oppositely disposed aperture end 68. A lip 70 extends from the mounting device end 66 of the first adapter section 60 (e.g., such that the lip 70 and first adapter section 60 are disposed in different orientations, such as orthogonal to each other). The first adapter section 60 may be characterized as being located somewhere between the lip 70 and the second adapter section 62.

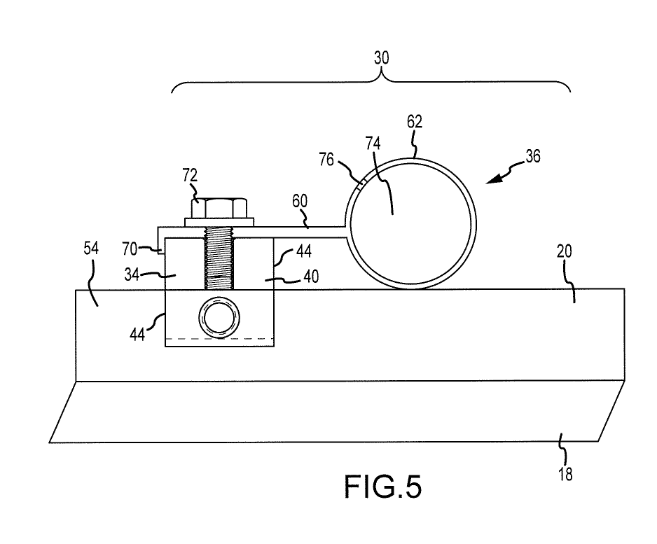

In order to detachably mount the adapter 36 to the mounting device 34, the first adapter section 60 may include a non-threaded adapter mounting hole 64 that is located between the mounting device end 66 and the aperture end 68 such that a threaded fastener 72 (FIGS. 2A-2B and 5) may extend through the adapter mounting hole 64 and into the mounting device 34, where the threaded fastener 72 is threadably engaged with the mounting device 34. Once again, it should be understood that the threaded fastener 72 (FIGS. 2A-2B and 5) could be in the form of a self-tapping fastener or a self-drilling fastener.

The second adapter section 62 of the adapter 36 includes a cross member-receiving aperture or pocket 74 of any appropriate size, shape, and/or configuration to accommodate the cross member 32. For example, the second adapter section 62 may form an aperture having a round, oval, square, rectangular, triangular, trapezoidal, or any other standard or custom shape.

The adapter 36 of FIG. 4 is shown installed on a mounting device in each of FIGS. 1, 2A, 2B, and FIG. 5. Referring now to these figures, the first adapter section 60 is positioned on at least one flat or planar upwardly facing or projecting surface of the mounting device 34 when installed on the roofing surface 12. In the illustrated embodiment, the first adapter section 60 is positioned on the upper surface 37 of the mounting device 34. In the installed position, the first adapter section 60 is parallel with the flat base sections 22 of the panels 18 that define the standing seam 20 with which the adapter 36 is interconnected, is parallel with the pitch of the roofing surface 12, or both.

The lip 70 of the adapter 36 facilitates alignment of the adapter 36 on the mounting device 34 for securing the two together. In the illustrated embodiment, when the lip 70 engages one of the mounting device ends 44, the adapter mounting hole 64 (of the adapter 36) is aligned with the threaded mounting hole 46 (of the mounting device 34) such that the threaded fastener 72 may be used to fix the adapter 36 to the mounting device 34. Moreover, the lip 70 also positions the second adapter section 62 a desired distance from the oppositely disposed mounting device end 40. The lip 70 may also keep the adapter 36 from rotating relative to the mounting device 34 as a threaded fastener 72 is used to secure the adapter 36 to the mounting device 34.

The second adapter section 62 is disposed beyond a mounting device end 44 of the mounting device 34 (the end 44 opposite that engaged by the lip 70 of the adapter 36), and as shown in FIGS. 2A, 2B, and 5. In the illustrated embodiment, this is provided by the first adapter section 60 extending beyond one of the mounting device ends 44. Other ways of disposing the second adapter section 62 beyond a mounting device end 44 could be utilized. In the illustrated embodiment, the second adapter section 62 is actually spaced from the adjacent-most mounting device end 44. This spacing or degree of separation between the adjacent-most mounting device end 44 and the second adapter section 62 (measured parallel with the pitch of the roofing surface 12) may be of any appropriate distance (e.g., a few inches, possibly more). Moreover, the second adapter section 62 could actually engage the adjacent-most mounting device end 44 (not shown).

FIG. 5 illustrates another feature of the cross member assembly 30. The second adapter section 62 is not only disposed beyond the adjacent-most mounting device end 44 of the mounting device 34, but it may be disposed on (i.e., contacts or engages) the same standing seam 20 that the mounting device 34 is installed upon. As such, the standing seam 20 may support the second adapter section 62 (and thereby the cross member 32 disposed therein) to at least some degree. The second adapter section 62 again includes the cross member-receiving aperture 74. Since the second adapter section 62 is disposed beyond an adjacent-most end 44 of the mounting device 34, so too is the cross member-receiving aperture 74. Increasing the spacing between the second adapter section 62 and the adjacent-most mounting device end 44 could actually enhance the retention of the cross member assembly 30 on the roofing surface 12 by increasing the moment arm (the distance between the mounting device 36 (a first contact with the roofing surface 12) and the second adapter section 62 (a spaced, second contact with the roofing surface 12)). This moment arm opposes forces exerted on the cross member assembly 30 by snow and/or ice proceeding down the slope of the roofing surface 12 that attempt to “pry” the cross member assembly 30 off of the roofing surface 12.

Part of the cross member-receiving aperture 74 (the lower portion thereof in the installed configuration) is also spaced closer to a first reference plane that includes the flat base sections 22 of the two panels 18 that define the seam 20 to which the adapter 36 is interconnected, compared to the flat section of the mounting device 34 that interfaces with the first adapter section 60 (the upper surface 37 in the illustrated embodiment). Part of the cross member-receiving aperture 74 is disposed above a second reference plane that contains the flat or planar portion of the surface on which the first adapter section 60 is disposed (the upper part of the cross member-receiving aperture 74 in the installed configuration), while part of the cross member-receiving aperture 74 is disposed below this second reference plane (the lower part of the cross member-receiving aperture 74 in the installed configuration).

The cross member-receiving aperture 74 is defined by a closed perimeter in the illustrated embodiment. That is, the second adapter section 62 extends about the entire perimeter of the cross member 32 (e.g., the second adapter section 62 is an annular structure or “encircles” the cross member 32, although neither of these characterizations limits the second adapter section 62 to having a circular cross member-receiving aperture 74). The second adapter section 62 may be characterized as a “loop”, or as a structure that limits or restrains movement in any direction that is away from the long axis of the cross member 32.

It may be possible for the cross member-receiving aperture 74 to not have a closed perimeter. However, if the cross member-receiving aperture 74 were reconfigured to include an opening for inserting the cross member 32 into the second adapter section 62, the boundary of the cross member-receiving aperture 74 should still provide stability for the cross member 32 when exposed to snow and/or ice sliding down the roofing surface 12—the cross member 32 should not be able to become dislodged from such a cross member-receiving aperture 74 due to sliding snow and/or ice engaging the cross member 32. In one embodiment for providing at least part of this functionality, part of the second adapter section 62 may be positioned “downhill” of the entire cross member 32 and this part may engage the cross member 32 to directly oppose forces exerted on the cross member 32 by snow and/or ice attempting to proceed down the roofing surface 12 (downhill being in the direction of decreasing elevation when the cross member assembly 30 is installed on the roofing surface 12). In one embodiment for providing at least part of the above-noted functionality, part of the second adapter section 62 may be disposed “downhill” of the most downhill portion of the cross member 32 to directly oppose forces exerted on the cross member 32 by snow and/or ice attempting to proceed down the roofing surface 12 (downhill being in the direction of decreasing elevation when the cross member assembly 30 is installed on a roofing surface). In one embodiment for providing at least part of the above-noted functionality, a first part of the second adapter section 62 that defines the cross-member receiving aperture 74 opposes movement of the cross member 32 away from the roofing surface 32 (e.g., is positioned “above” the cross member 32), a second part of the second adapter section 62 that defines the cross-member receiving aperture 74 opposes movement of the cross member 32 towards the roofing surface 12 (e.g., is positioned “below” the cross member 32), and a third part of the second adapter section 62 that defines the cross-member receiving aperture 74 is positioned “downhill” of the cross member 32 so as to oppose movement of the cross member 32 down the pitch of the roofing surface 12.

The second adapter section 62 may also include an cross member mounting hole 76 for selectively fixing the cross member 32 relative to the second adapter section 62 via a fastener 78, such as a set screw (FIGS. 2A-B). Thus, the cross member 32 may extend through the cross member-receiving aperture 74 of the second adapter section 62, and may be at least somewhat locked thereto via the fastener 78.

Another embodiment of an adapter is shown in FIG. 6, is identified by reference numeral 36′, and may be used by the cross member assembly 30 in place of the above-discussed adapter 36. Common parts of the two adapters are identified by the same reference numeral. Those corresponding parts in the FIG. 6 embodiment that differ from the embodiment shown in FIGS. 1-5 are identified by a “single prime” designation. Generally, the first adapter section 60 in the case of the adapter 36 of FIGS. 1-5 may be characterized as a single-layer or a single-piece structure, while the first adapter section 60′ of the adapter 36′ of FIG. 6 is collectively defined by two layers or sections that may be disposed in interfacing relation.

The adapter 36′ of FIG. 6 includes modified first and second adapter sections 60′, 62′ that differ in certain respects from the first and second adaptor sections 60, 62 discussed above with respect to the embodiment of FIG. 4. Specifically, the first adapter section 60′ includes a top flange 80 and a separate bottom flange 82. These top and bottom flanges 80, 82 collectively define a flat plate (the first adapter section 60′) having a mounting device end 88 and an aperture end 90. While FIG. 6 shows the lip 70 extending (e.g., orthogonally) from the mounting device end 88 of the top flange 80, the lip 70 could extend from a mounting device end 88 of the bottom flange 82 (not shown).

The top and bottom flanges 80, 82 are connected via the second adapter section 62′, which may act as a living hinge between the top and bottom flanges 80, 82 to allow the top and bottom flanges 80, 82 to be moved between open and closed positions. That is, the top and bottom flanges 80, 82 may be moved apart to provide access to the cross member-receiving aperture 74, and when the second adapter section 62′ is disposed about the cross member 32, the top and bottom flanges 80, 82 may be moved back together (i.e., disposed in interfacing relation) such that the second adapter section 62′ provides a closed perimeter to restrain the cross member 32 within the cross member-receiving aperture 74. The second adapter section 62′ may be formed of any appropriate material or have any appropriate thickness and/or configuration so as to provide second adapter section 62′ with sufficient flexibility to hinge the top and bottom flanges 80, 82 between open and closed positions.

To attach the adapter 36′ to the mounting device 34, the top flange 80 may include a non-threaded first adapter mounting hole 84, and the bottom flange 82 may include a non-threaded second adapter mounting hole 86. When the top and bottom flanges 80, 82 are mated, the first and second adapter mounting holes 84, 86 align such that a fastener 72 (FIGS. 2A-2B and 5) may extend through the first and second adapter mounting holes 84, 86 and into the mounting device 34 in the manner noted above.

Each of the adapters 62, 62′ addressed herein may be formed from any appropriate material or combination of materials. Moreover, each of the adapters 62, 62′ may be an integrally formed structure—of one-piece construction such that there is no joint of any kind between adjacent portions.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A cross member assembly, comprising:
a mounting device comprising first and second mounting device ends and an upper surface that comprises a flat section, wherein when said mounting device is installed on a roofing surface said upper surface projects upwardly and said first and second mounting device ends are spaced from each other proceeding along a slope of the roofing surface;
an adapter detachably mounted on said mounting device and comprising first and second adapter sections, wherein said first adapter section is a plate that is disposed on said flat section of said upper surface of said mounting device, wherein said second adapter section is interconnected with said first adapter section, is disposed beyond said first mounting device end, and comprises a cross member-receiving aperture that is also disposed beyond said first mounting device end, and wherein said cross member-receiving aperture is defined by a closed perimeter.

2. The cross member assembly of claim 1, further comprising at least one fastener for securing said mounting device to a roofing surface.

3. The cross member assembly of claim 1, wherein said mounting device comprises a mounting body and at least one seam fastener, wherein said mounting body comprises a seam-receiving slot, and wherein said at least one seam fastener extends through said mounting body and into said seam receiving slot.

4. The cross member assembly of claim 1, wherein said adapter comprises a registrant to align said adapter relative to said mounting device.

5. The cross member assembly of claim 1, wherein said adapter further comprises a lip that extends from said first adapter section in a different orientation than said first adapter section.

6. The cross member assembly of claim 5, wherein said lip engages said second mounting device end.

7. The cross member assembly of claim 1, wherein said first adapter section comprises an adapter mounting hole that is free of threads.

8. The cross member assembly of claim 7, wherein said upper surface of said mounting device comprises a threaded hole, and wherein said mounting assembly further comprises a threaded fastener that extends through said adapter mounting hole and into said threaded hole of said mounting device.

9. The cross member assembly of claim 7, further comprising:
a self-tapping or self-drilling fastener that extends through said adapter mounting hole of said first adapter section and into said mounting device.

10. The cross member assembly of claim 1, wherein said first adapter section comprises a top flange and a separate bottom flange that collectively define said plate.

11. The cross member assembly of claim 10, wherein said top flange comprises a first adapter mounting hole and said bottom flange comprises a second adapter mounting hole, and wherein said first and second adapter mounting holes are aligned when said top and bottom flanges are mated.

12. The cross member assembly of claim 10, wherein said top and bottom flanges are movable apart to provide access to said cross member-receiving aperture of said second adapter section, and wherein said top and bottom flanges are movable together to restrain a cross member within said cross member-receiving aperture of said second adapter section.

13. The cross member assembly of claim 10, wherein said upper surface of said mounting device comprises a threaded hole, and wherein said mounting assembly further comprises a threaded fastener that extends through said first and second adapter mounting holes of said first adapter section and into said threaded hole of said mounting device.

14. The cross member assembly of claim 10, further comprising:
a self-tapping or self-drilling fastener that extends through said first and second adapter mounting holes of said first adapter section and into said mounting device.

15. The cross member assembly of claim 10, wherein said second adapter section comprises a living hinge between said top and bottom flanges, and wherein said living hinge allows said adapter to be moved between open and closed positions.

16. The cross member assembly of claim 15, wherein said open position allows a cross member to be loaded into and removed from said cross member-receiving aperture.

17. The cross member assembly of claim 15, wherein when in said closed position, said top and bottom flanges of said first adapter section are disposed in interfacing relation and said second adapter section provides said closed perimeter for said cross member-receiving aperture.

18. The cross member assembly of claim 1, wherein said first adapter section is defined by a single layer.

19. The cross member assembly of claim 1, wherein when said mounting assembly is installed on a roofing surface, said first adapter section is parallel to a slope of the roofing surface.

20. The cross member assembly of claim 1, wherein said second adapter section adjoins said first adapter section.

21. The cross member assembly of claim 1, wherein said second adapter section comprises a closed loop.

22. The cross member assembly of claim 1, wherein said second adapter section is spaced from said first mounting device end.

23. The cross member assembly of claim 1, wherein said second adapter section abuts said first mounting device end.

24. The cross member assembly of claim 1, further comprising:
a cross member disposed within said cross member-receiving aperture of said second adapter section.

25. The cross member assembly of claim 24, wherein said cross member extends orthogonally to a direction in which said first and second mounting device ends are spaced from each other.

26. The cross member assembly of claim 24, further comprising:
a set screw that extends through said second adapter section and into engagement with said cross member.

27. A roofing system comprising a roofing surface and the cross member assembly of claim 1, wherein said mounting device is detachably engaged with said roofing surface.

28. The roofing system of claim 27, wherein said cross member-receiving aperture of said second adapter section is disposed in a direction of decreasing elevation from said mounting device when said cross member assembly is engaged with said roofing surface.

29. The roofing system of claim 26, wherein said roofing surface comprises a plurality of standing seams and at least one flat base section between each adjacent pair of said standing seams, wherein said mounting device is mounted on one of said standing seams, and wherein said second adapter section is engaged with said one of said standing seams.

30. The roofing system of claim 29, wherein said first adapter section is parallel with each said base section.
